(19) United States
(12) Patent Application Publication
(10) Pub. No.: US 2015/0253937 A1
(43) Pub. Date: Sep. 10, 2015

(54) DISPLAY APPARATUS AND METHOD OF PERFORMING A MULTI VIEW DISPLAY THEREOF

(71) Applicant: SAMSUNG ELECTRONICS CO., LTD., Suwon-si (KR)

(72) Inventors: Young-woo KIM, Suwon-si (KR); Seung-jun LEE, Yongin-si (KR)

(73) Assignee: SAMSUNG ELECTRONICS CO., LTD., Suwon-si (KR)

(21) Appl. No.: 14/638,498

(22) Filed: Mar. 4, 2015

(30) Foreign Application Priority Data
Mar. 5, 2014 (KR) 10-2014-0026030
May 29, 2014 (KR) 10-2014-0064872
Jan. 6, 2015 (KR) 10-2015-0001078

(51) Int. Cl. G06F 3/0481; G06F 3/0484; G06F 3/0488; H04N 13/04

(52) U.S. Cl. CPC G06F 3/0481; H04N 13/0447; G06F 3/04847; G06F 3/0488

(57) ABSTRACT

A display apparatus is provided. The display apparatus includes a display, a sensor configured to sense a user gesture, a content receiver configured to receive contents from a plurality of input sources, and a controller configured to, in response to a first user gesture being sensed, control the display to respectively display preview images of a plurality of contents received from the plurality of input sources in each of a plurality of split screens, and in response to a second user gesture of selecting a plurality of split screens being sensed, control the display to simultaneously display a plurality of contents corresponding to preview images displayed in a plurality of selected split screens.

### CROSS-REFERENCE TO RELATED APPLICATIONS

This application claims priority under 35 U.S.C. §119 from Korean Patent Application No. 10-2014-0026030, filed on Mar. 5, 2014 in the Korean Intellectual Property Office, Korean Patent Application No. 10-2014-0064872, filed on May 29, 2014 in the Korean Intellectual Property Office, and Korean Patent Application No. 10-2015-0001078, filed on Jan. 6, 2015 in the Korean Intellectual Property Office the disclosure of which is incorporated herein by reference in its entirety.

### BACKGROUND

1. Field of the Invention

The present general inventive concept generally relates to a display apparatus and a method of performing a multi view display thereof, and more particularly, to a display apparatus which simultaneously displays a plurality of contents according to a user gesture and a method of performing a multi view display thereof.

2. Description of the Related Art

With the development of electronic technologies, various types of electronic products have been developed and have come into wide use. In particular, various display apparatuses, such as a television (TV), a mobile phone, a Personal Computer (PC), a laptop PC, a Personal Digital Assistant (PDA), and the like, are widely used in a general domestic environment.

According to increasing use of the electronic products, user needs regarding more various functions also increase. Accordingly, manufacturers of the electronic products have made an effort to satisfy the user needs, and thus, products providing new functions which were previously nonexistent are appearing.

Recently, a display apparatus providing a multi view mode has come into wide use. A multi view mode refers to a mode in which a plurality of different contents are displayed by using a single display apparatus. A display apparatus may operate selectively in either of a normal mode in which a content is displayed and a multi view mode.

In order to switch a mode of a display apparatus from a normal mode to a multi view mode, a user should manipulate the display apparatus several times. To be specific, in response to a user manipulation of pressing a button for a multi view mode mounted on a remote controller or the display apparatus, the display apparatus displays input sources which currently provide the display apparatus with various contents in a text form.

For example, a display apparatus displays a TV, a High Definition Multimedia Interface (HDMI) 1, a HDMI 2, and a Component in a row, and every time a user presses a up/down button mounted on a remote controller, moves and displays the TV, the HDMI 1, the HDMI 2, and the Component as in an activated state. In response to a select button being pressed by the user while any one of the TV, the HDMI 1, the HDMI 2, and the Component is displayed as in the activated state, an input source for a multi view mode may be selected.

In response to at least one or more input sources additionally being selected by the user according to the aforementioned method, the display apparatus may receive contents from the input sources selected by the user and perform the multi view display.

As described above, in order to switch a mode of the display apparatus from a normal mode to a multi view mode, the user should perform a plurality of input operations. Specially, considering that the number of input sources increases as contents become diversified, the number of user manipulations for selecting an input source also increases.

In addition, the display apparatus displays the input sources in text form, and thus, the user is not able to know which content is provided from the input sources. Accordingly, as described above, in response to the multi view display being performed after the input sources for the multi view mode are selected, the user is able to see the content provided from the input source that the user selected. In response to an undesired content, the user should perform the aforementioned operations again. Accordingly, such inconvenience in performing the multi view mode may decrease usability of the multi view mode.

### SUMMARY

The present disclosure has been provided to address the aforementioned and other problems and disadvantages occurring in the related art, and an aspect of the present disclosure provides a display apparatus which simultaneously displays a plurality of contents according to a user gesture and a method of performing a multi view display thereof.

According to an exemplary embodiment, a display apparatus includes a display, a sensor configured to sense a user gesture, a content receiver configured to receive contents from a plurality of input sources, and a controller configured to, in response to a first user gesture being sensed, control the display to respectively display preview images of a plurality of contents received from the plurality of input sources in each of a plurality of split screens, and in response to a second user gesture of selecting a plurality of split screens being sensed, control the display to simultaneously display a plurality of contents corresponding to preview images displayed in a plurality of selected split screens.

The controller may control the display to respectively display the plurality of contents corresponding to the preview images displayed in the plurality of selected split screens in different areas.

In addition, the controller may control the display to alternately display the plurality of contents corresponding to the preview images displayed in the plurality of selected split screens on a frame basis.

The apparatus may further include a content processor configured to generate the plurality of contents corresponding to the preview images displayed in the plurality of selected split screens as a multi view content corresponding to a predetermined multi view mode and provide the display with the generated multi view content.

In response to the first user gesture being sensed multiple times, the controller may change a number of the split screens according to a number of times the first user gesture is sensed.

In response to a third user gesture for changing a content preview image displayed in each of the split screens being sensed, the controller may change the content preview image in each of the split screens according to the third user gesture.

In response to the second user gesture for connecting one of the plurality of split screens to at least one another split screen being sensed, the controller may control the display to simultaneously display a plurality of contents corresponding to preview images displayed in each of the split screens connected by the second user gesture.

The second user gesture may be a gesture which individually selects a plurality of split screens.

In response to a predetermined time elapsing preview images of a plurality of contents received from the plurality of input sources are displayed in each of a plurality of split screens, the controller may control the display to display only a content received from a pre-selected input source from among the plurality of input sources.

The controller may control the display to display identification information on each of a plurality of input sources in each of the plurality of split screens.

In response to a fourth user gesture being sensed while a plurality of contents are simultaneously displayed, the controller may control the display to display only a content received from a pre-selected input source.

According to an exemplary embodiment, a method of displaying a multi view of a display apparatus includes receiving contents from a plurality of input sources, in response to a first user gesture being sensed, respectively displaying preview images of a plurality of contents received from the plurality of input sources in each of a plurality of split screens, and in response to a second user gesture of selecting a plurality of split screens being sensed, simultaneously displaying a plurality of contents corresponding to preview images displayed in the plurality of selected split screens.

The simultaneously displaying the plurality of contents may include respectively displaying the plurality of contents corresponding to the preview images displayed in the plurality of selected split screens in different areas of a screen.

The simultaneously displaying the plurality of contents may include alternately displaying the plurality of contents corresponding to the preview images displayed in the plurality of selected split screens on a frame basis.

The method may further include generating the plurality of contents corresponding to the preview images displayed in the plurality of selected split screens as a multi view content corresponding to a predetermined multi view mode.

In response to the first user gesture being sensed multiple times, the respectively displaying the preview images of the plurality of contents received from the plurality of input sources in each of the plurality of split screens may include changing a number of the split screens according to a number of times the first user gesture is sensed.

The method may further include, in response to a third user gesture for changing a content preview image displayed in each of the split screens being sensed, changing the content preview image in each of the split screens according to the third user gesture.

In response to the second user gesture for connecting one of the plurality of split screens to at least another split screen being sensed, the simultaneously displaying the plurality of contents may include simultaneously displaying a plurality of contents corresponding to preview images displayed in each of the split screens connected by the second user gesture.

The second user gesture may be a gesture which individually selects a plurality of split screens.

The method may further include, in response to a predetermined time elapsing while preview images of a plurality of contents received from the plurality of input sources are displayed in each of a plurality of split screens, displaying only a content received from a pre-selected input source from among the plurality of input sources.

The respectively displaying the preview images of the plurality of contents received from the plurality of input sources in each of the plurality of split screens may include displaying identification information on each of the plurality of input sources in each of the plurality of split screens.

The method may further include, in response to a fourth user gesture being sensed while a plurality of contents are displayed, displaying only a content received from a pre-selected input source.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a diagram illustrating a multi view display system according to an exemplary embodiment;

FIG. 2 is a block diagram illustrating a structure of a display apparatus according to an exemplary embodiment;

FIGS. 3A to 3C are diagrams provided to describe a method of displaying a split screen according to a first user gesture, according to various exemplary embodiments;

FIGS. 4A to 4B are diagrams provided to describe a method of changing an image in a split screen according to a third user gesture, according to various exemplary embodiments;

FIGS. 5A to 5B are diagrams provided to describe a method of simultaneously displaying a plurality of contents according to a second user gesture, according to various exemplary embodiments;

FIGS. 6A to 6B are diagrams provided to describe a method of displaying a multi view content according to various exemplary embodiments;

FIGS. 7A to 7C are diagrams provided to describe a method of controlling a display apparatus according to a fourth user gesture, according to various exemplary embodiments; and

FIG. 8 is a flow chart provided to describe a method of displaying a multi view according to an exemplary embodiment.

### DETAILED DESCRIPTION OF PREFERRED EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

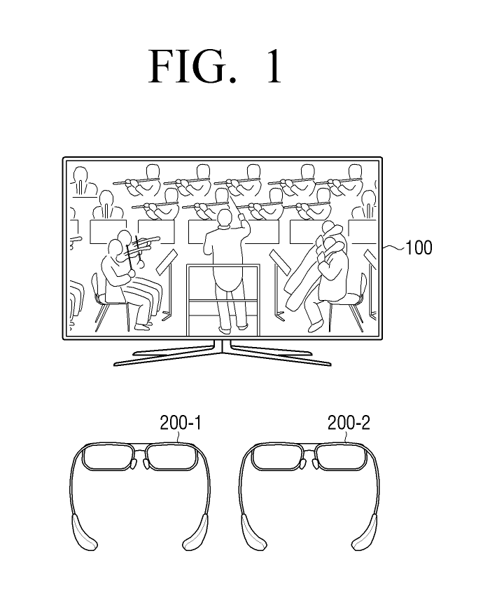

FIG. 1 is a diagram illustrating a multi view display system according to an exemplary embodiment. In the multi view display system, a user is able to watch a plurality of contents through a single display apparatus.

Specially, referring to FIG. 1, the multi view display system may include a display apparatus 100 and at least two or more eyeglasses 200-1 and 200-2.

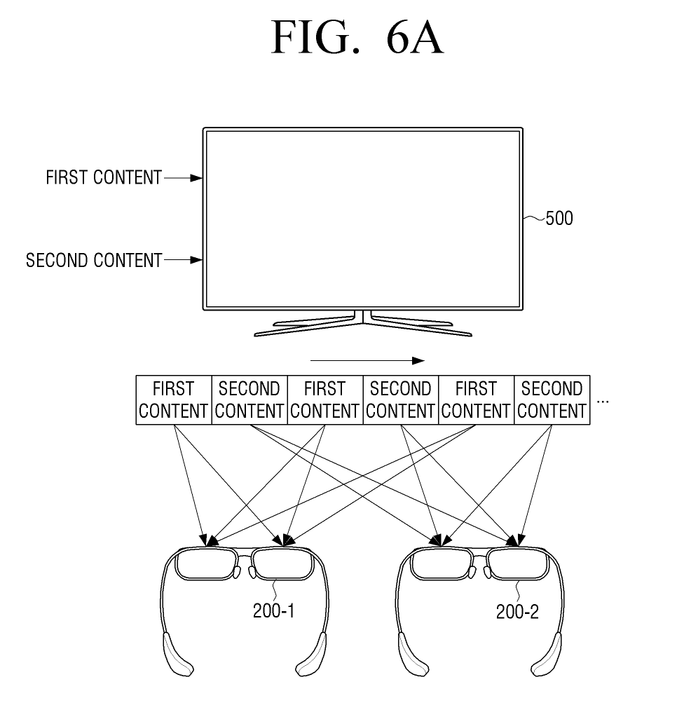

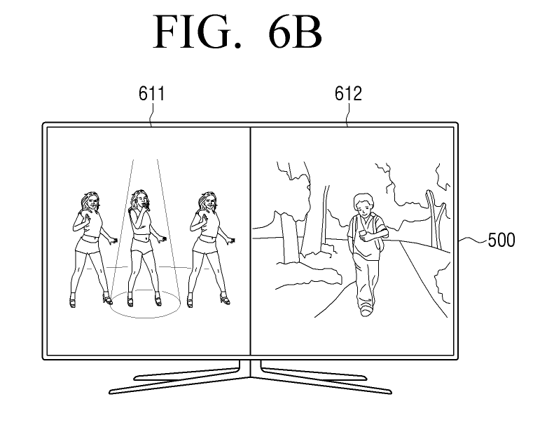

In response to the display apparatus 100 simultaneously displaying a plurality of contents, each of a plurality of users is able to watch a desirable content with wearing the eyeglasses 200-1 and 200-2, respectively. The exemplary embodiment of watching contents using the eyeglasses 200-1, 200-2 will be described below in further detail with reference to FIG. 6B.

Meanwhile, according to another exemplary embodiment, the display apparatus 100 may respectively display a plurality of contents in different areas of a screen. Accordingly, a user is able to watch the plurality of contents in a single screen. In this case, an audio of a desired content may be individually provided to the user. For example, each of a plurality of users is able to listen to an audio of only the desired content using headphone. The exemplary embodiment will be described below in further detail with reference to FIG. 6A.

The display apparatus 100 may be embodied as various apparatuses having a display unit, such as a TV, a mobile phone, a PDA, a laptop PC, a monitor, a tablet PC, an electronic book, an electronic picture frame, a kiosk, etc.

The display apparatus 100 is an apparatus which may display a content or simultaneously display a plurality of different contents. To be specific, the multi view mode may be called a dual view mode in case of displaying two contents, may be called a triple view mode in case of displaying three contents, and may be called a quadruple view mode in case of displaying four contents.

In response to each of a plurality of users who wishes to view different content by using the single display apparatus 100, a predetermined method may be used. In this case, the predetermined method may be a method of taking the first user gesture, but is not limited thereto. That is, a method of selecting a certain button which is mounted on a remote controller may be used.

In response to the first user gesture being sensed, the display apparatus 100 may display images regarding a plurality of contents received from a plurality of input sources in each of a plurality of split screens. The images regarding the contents which are respectively displayed in each of the plurality of split screens relate to different contents, and may be provided from different input sources.

In this case, the plurality of split screens refer to screens which are distinguished from each other by images displayed in each split screen. Meanwhile, the display apparatus 100 may distinguish the split screens by displaying a boundary line, and a size or a shape of each split screen may be the same as or different from each other.

Meanwhile, the present disclosure may be realized as a display system which consists of a plurality of display apparatuses (for example, a video wall). In this case, a split screen may refer to a screen which is displayed by a single display apparatus constituting the display system or refers to a screen which is displayed by two or more display apparatuses. Hereinafter, only an exemplary embodiment of realizing the present disclosure as a single display apparatus will be described for convenience in explanation.

An image regarding a content displayed in each split screen may be an image which represents the content (for example, a movie poster), an image related to the content (for example, a preview image of the content), or an image where the content itself is displayed. Alternatively, each split screen may display texts representing the content, such as a title or summary of the content, separately or with an image. Accordingly, an image regarding a content displayed in a split screen may include any types of images which may identify a content, such as an image, a picture, a moving image, texts, and the like. Hereinafter, it is assumed that the image regarding a content displayed in a split screen is a preview image of a content.

In response the first user gestures additionally being sensed while the content preview images are displayed on the plurality of split screens, the display apparatus 100 may change the number of the split screens according to the number of times the first user gesture is sensed. For example, in response to a user gesture of putting the thumb and an index finger of the user together so as to touch, while at the same time touching a display screen with the fingers, the display apparatus 100 increases the number of split screens. In this case, in response to the split screens increasing from two screens to four screens, four different content preview images may be displayed on each of the four split screens.

In addition, in response to sensing the first user gesture again while the four split screens are displayed, the display apparatus 100 may display six split screens or eight split screens. In this case, different content preview images may be displayed on the six split screens or the eight split screens, respectively.

In response to the number of the split screens being changed according to the aforementioned method, the display apparatus 100 may display identification information on the input sources which provide each content preview image on each of the split screens along with the content preview images.

Meanwhile, in response to the split screens being generated according to the number that the user desires by the aforementioned operations, the user is able to perform the second user gesture of selecting a plurality of split screens.

In response to the second user gesture of selecting a plurality of split screens being sensed, the display apparatus 100 may simultaneously display a plurality of contents corresponding to the content preview images displayed in the plurality of selected split screens. To be specific, the display apparatus 100 may receive contents from a plurality of input sources, generate the plurality of received content as a multi view content, and display the generated multi view content.

A multi view content refers to a new content which is generated as a plurality of contents are processed so that a plurality of contents are displayed in a single screen, and the multi view content may include various types of multi view contents which vary depending upon a displaying form. As an example, the multi view content may be a content which is displayed as a plurality of contents occupy different areas in a screen. As another example, the multi view content may be a content which is displayed as a plurality of content are alternately displayed on a frame basis.

In this case, the second user gesture may be a gesture of, while a plurality of split screens are displayed, selecting two or more split screens from among the plurality of displayed split screens.

Accordingly, in response to the second user gesture being sensed, the display apparatus 100 processes a plurality of contents received from a plurality of input sources corresponding to the preview images displayed in the split screen selected by the second user gesture, generates a multi view content, and displays the generated multi view content.

As described above, the display apparatus 100 may provide the preview images of the contents and identification information on the input sources corresponding to the content images in a plurality of split screens and simultaneously display a plurality of contents only by sensing a user gesture. Accordingly, the user is able to select the contents to be displayed while checking the preview images of the contents and the input sources, and control the display apparatus 100 to simultaneously display a plurality of contents only by a simple gesture.

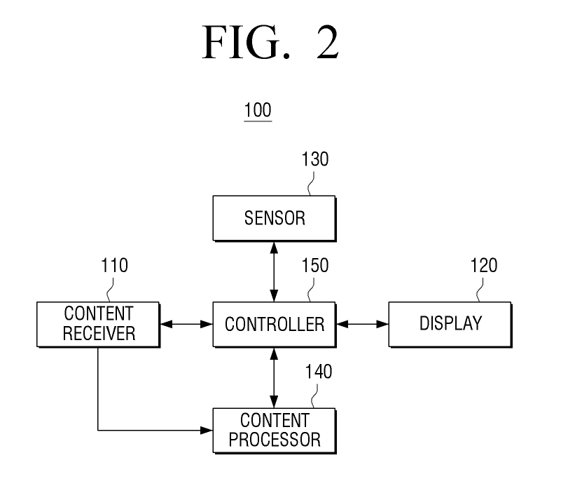

FIG. 2 is a block diagram illustrating a structure of a display apparatus according to an exemplary embodiment. Referring to FIG. 2, the display apparatus 100 includes a content receiver 110, a display 120, a sensor 130, a content processor 140, and a controller 150.

The content receiver 110 is connected to a plurality of input sources which provide contents, and receives the contents from at least one of the plurality of input sources according to an operation mode of the display apparatus 100. The plurality of input sources may include a TV1, a TV2, the HDMI 1, the HDMI 2, a Universal Serial Bus (USB), internet, etc., but not limited thereto, may further include other input sources.

In response to the display apparatus 100 operating so as to display only one content, the content receiver 110 may receive the contents from a source pre-selected by the user. In response to the display apparatus 100 operating so as to display a plurality of contents, the content receiver 110 may receive the contents from two or more input sources selected by the user.

The display 120 displays the contents received through the content receiver 110. To be specific, in response to the display apparatus 100 operating so as to display a content, the display 120 displays a content received through the content receiver 110. In this case, the one content may be a multimedia signal which is image processed or voice processed by the content processor 140.

In response to the display apparatus 100 operating so as to display a plurality of contents, the display 120 may display a plurality of contents received through the content receiver 110. In this case, the plurality of content received through the content receiver 110 may be processed by the content processor 140 and displayed in a form of a multi view content.

The sensor 130 senses various user gestures related to the multi view mode. To be specific, the sensor 130 may sense the first to fourth user gestures related to the multi view mode. In an exemplary embodiment, the sensor 130 may be a touch screen combined with the display 120.

The first user gesture is a gesture for displaying a plurality of split screens which respectively display preview images of a plurality of contents in response to the user who wishes to watch a plurality of contents in the middle of watching a content. The first user gesture may include a gesture of putting a thumb and an index finger of a user together so as to touch each other while simultaneously touching the display 120 with the fingers.

The second user gesture is a gesture of selecting a plurality of split screens corresponding to a plurality of contents that a user wishes to watch. The second user gesture may include a gesture of connecting a certain split screen and at least one another split screen with a finger (for example, an index finger), for example.

The third user gesture is a gesture for changing a preview image of a content displayed on at least one split screen. The third user gesture may include a gesture of moving a finger (for example, an index finger) in either of up, down, left, and right directions while touching a certain split screen with the finger, for example. In this case, a process where the preview image is changed in a user touch direction may be shown.

The fourth user gesture is a gesture for terminating an execution of the multi view mode while the multi view mode is being executed. The fourth user gesture may include a gesture of spreading a thumb and an index finger which are faced while touching the display 120 with the fingers, for example.

Meanwhile, it was described that the sensor 130 may be a touch screen, but not limited thereto. That is, the display apparatus 100 may take a picture of a user by using a camera (not shown) mounted on a front side of the display apparatus 100, and may sense a user gesture from the picture of the user. Alternatively, the display apparatus 100 may communicate with a wearable device (for example, a smart watch) that a user wears to sense a user gesture. In response to the user gesture being sensed according to aforementioned method, the user may control the display apparatus 100, without touching the display apparatus 100.

The content processor 140 processes the contents received through the content receiver 110.

To be specific, in response to the display apparatus 100 operating so as to display a content, the content receiver 110 may receive a content from an input source. Accordingly, the content processor 140 processes the content, and provides the display 120 with the content.

In response to the display apparatus 100 operating so as to display a plurality of contents, the content receiver 110 may receive at least two contents from at least two input sources. Accordingly, the content processor 140 generates a plurality of content as a multi view content and provides the display 120 with the generated multi view content.

In this case, the content processor 140 may generate the plurality of contents as a multi view content corresponding to a predetermined multi view mode.

According to various exemplary embodiments, various multi view modes may exist, and the content processor 140 may generate a multi view content corresponding to the predetermined multi view mode among the various multi view modes. Meanwhile, a multi view mode may be determined by characteristics of an external apparatus which is sensed by the display apparatus 100. For example, in response to the eyeglasses 200-1, 200-2 being sensed by the display apparatus 100 (for example, in response the eyeglasses being turned on), a multi view content corresponding to the multi view mode which is suitable for the eyeglasses 200-1, 200-2 may be generated.

As an example, in a multi view content corresponding to a first multi view mode, a plurality of contents may be alternately displayed on a frame basis. For example, a frame of a first content and a frame of a second content may be displayed alternately. In this case, the first content and the second content are shown as being mixed if a user watches the contents with naked eyes. However, if a user watches the contents using special eyeglasses 200-1, 200-2, only the frame of the first content or only the frame of the second content may be shown through the eyeglasses. As the result, the user is able to watch only a desired content. The present exemplary embodiment will be described below in further detail with reference to FIG. 6A.

As another example, in a multi view content corresponding to a second multi view mode, a plurality of contents are displayed in different areas of a screen. In this case, the controller 150 may control the display 120 so that the plurality of contents are displayed in respective areas with having boundary lines. In this case, a user is able to watch the plurality of contents simultaneously and able to listen to an audio regarding only a desired content using the headphone and the like. In this case, the headphone may be connected to the display apparatus 100 or may be connected to a portable device (for example, a smart phone or a remote controller) which communicates with the display apparatus 100. The present exemplary embodiment will be described below in further detail with reference to FIG. 6B.

The controller 150 controls overall operations of the display apparatus 100.

In response to the first user gesture being sensed through the sensor 130, the controller 150 controls the display 120 to respectively display preview images of a plurality of contents received from a plurality of input sources in a plurality of split screens. In this case, in response to the first user gesture being sensed multiple times, the controller 150 may control the display 120 to change the number of the split screens according to the number of times being sensed of the first user gesture. In this case, the controller 150 may control the display 120 to further display identification information on a plurality of input sources corresponding to the preview images of the contents displayed in each of the split screens in the plurality of split screens.

In response to the second user gesture for selecting at least two or more split screens from among a plurality of split screens being sensed through the sensor 130, the controller 150 control the display 120 to simultaneously display a plurality of contents corresponding to preview images of a plurality of contents in a plurality of split screens selected by the second user gesture. That is, the controller 150 may control the content receiver 110 and the content processor 140 to receive a plurality of contents from the input sources corresponding to the plurality of contents and generate a multi view image.

In addition, in response to the third user gesture for changing a preview image of a content displayed in a split screen being inputted, the controller 150 controls the display 120 to change the preview image of the content in the split screen according to the third user gesture. That is, the controller 150 changes the input source of the split screen in which the third user gesture is sensed.

Meanwhile, a predetermined time elapsing while the preview images of the contents are displayed in the plurality of split screens, the controller 150 controls the display 120 to display a content received from a pre-selected input source from among a plurality of input sources. Herein, the pre-selected input source may include an input source of a content which is displayed before the split screens are displayed by the first user gesture or an input source which is set by default.

In addition, in response to the fourth user gesture being sensed while the plurality of contents are displayed on the display 120, the controller 150 may control the display 120 to display only the content received from the pre-selected input source. That is, in response to the fourth user gesture being sensed, the controller 150 may terminate a state where a plurality of contents are displayed.

In response to the state where a plurality of contents are displayed being terminated, the controller 150 controls the display 120 to display the content which is selected by a user or a received from the pre-selected input source.

Meanwhile, according to another exemplary embodiment, the controller 150 may control the display 120 to display only one content in a manner of decreasing the number of the split screens according to the number of times being sensed of the fourth user gesture.

With reference to the display apparatus 100 shown in FIG. 2, a user is able to change the number of contents which are displayed in the display apparatus 100 only by taking a gesture.

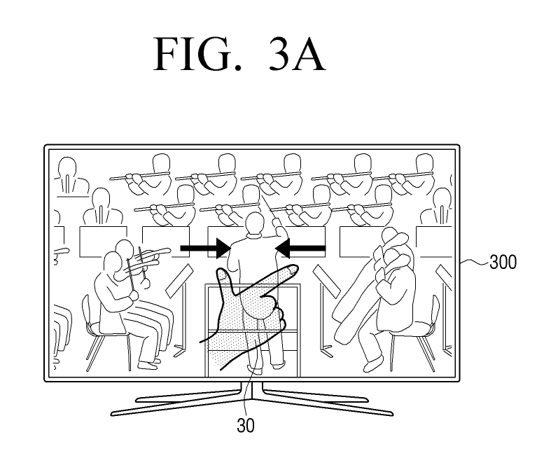

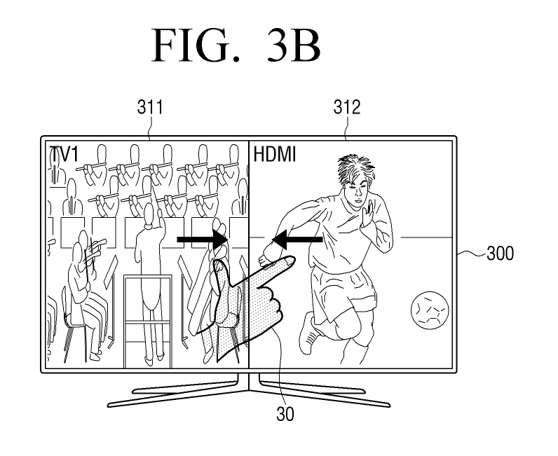

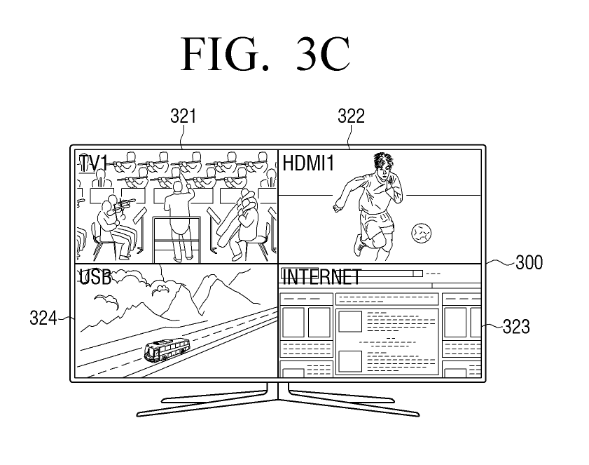

FIGS. 3A to 3C are diagrams provided to describe a method of displaying a split screen according to a first user gesture according to an exemplary embodiment.

Referring to FIG. 3A, a display apparatus 300 operates so as to display a content in a screen. In response to the first user gesture being taken in this state by the user with a hand 30, as illustrated in FIG. 3b, the display apparatus 300 displays two split screens 311 and 312.

To be specific, in response to a user gesture of putting a thumb and an index finger of a user together so as to touch each other while simultaneously touching a screen with the fingers, the display apparatus 300 displays a first split screen 311 including a preview image of a first content and a second split screen 312 including a preview image of a second content, as shown in FIG. 3B.

The display apparatus 300 may display the “TV1” which corresponds to the preview image of the first content, that is, source information providing a content corresponding to the preview image of the first content on the first split screen 311 along with the first content image. In addition, the display apparatus 300 may display the “HDMI1” which is source information providing a content corresponding to the preview image of the second content on the second split screen 312 along with the second content image.

Accordingly, the user is able to know that the content corresponding to the preview image of the first content displayed on the first split screen 311 is received from the “TV1,” and the content corresponding to the preview image of the second content displayed on the second split screen 312 is received from the “HDMI1.” As such, the user is able to select a plurality of contents to be displayed with checking the preview images of the contents provided from each source.

Meanwhile, in case of using the two split screens 311 and 312 as shown in FIG. 3B, the user is able to select only two contents. Accordingly, for the triple view mode or the quadruple view mode, more split screens are needed.

Accordingly, in response the first user gesture being taken once again by the user with the hand 30 on a screen, as shown in FIG. 3B, the display apparatus 300 displays four split screens 321 and 322 which include each of the preview images of the contents, as shown in FIG. 3C.

To be specific, the display apparatus 300 displays the first split screen 321 including the preview image of the first content, the second split screen 322 including the preview image of the second content, a third split screen 323 including a preview image of a third content, and a fourth split screen 324 including a preview image of a fourth content.

The display apparatus 300 may display the “TV1” which is the source information providing a content corresponding to the preview image of the first content on the first split screen 321 along with the preview image of the first content, and display the “HDMI1” which is the source information providing a content corresponding to the preview image of the second content on the second split screen 322 along with the preview image of the second content. In addition, the display apparatus 300 may display an “Internet” which is source information providing a content corresponding to the preview image of the third content on the third split screen 323 along with the preview image of the third content, and display a “USB” which is source information providing a content corresponding to the preview image of the fourth content on the fourth split screen 324 along with the preview image of the fourth content.

In response to four or more contents being selectable by the user, the user is able to take the first user gesture again on the screen shown in FIG. 3C. Accordingly, the display apparatus 300 may display six, eight, or sixteen split screens including preview images of different content images. The number of split screens may be configured according to the number of times the first user gesture is sensed, and may be increased to be 2N or 2^{N}, etc. In this case, N may be the number of times being sensed of the first user gesture.

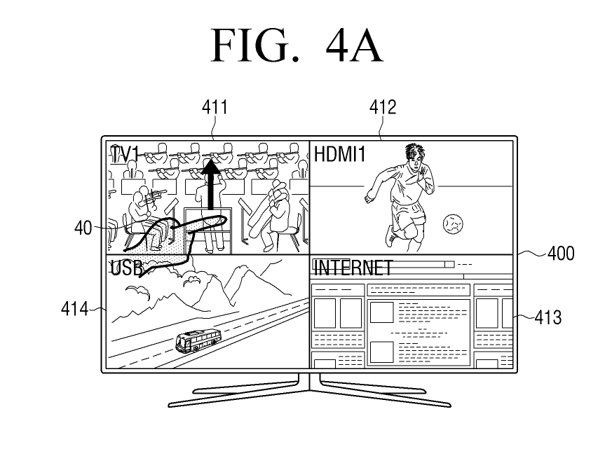

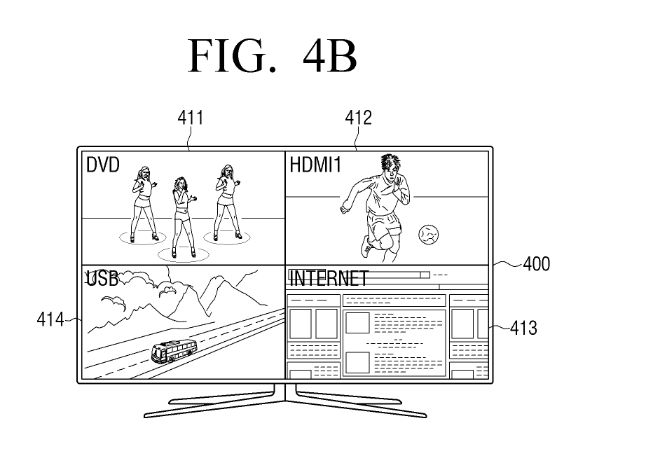

FIGS. 4A to 4B are diagrams provided to describe a method of changing a preview image of content according to a third user gesture. Referring to FIG. 4A, a display apparatus 400 displays a first to fourth split screens 411, 412, 413, and 414 including preview images of different content images. In this case, the first to fourth split screens 411, 412, 413, and 414 may be displayed according to the method shown in FIGS. 3A to 3C.

The user is able to select contents that the user wishes to watch while simultaneously checking-preview images of the contents displayed through the first to fourth split screens 411, 412, 413, and 414 and the input sources corresponding thereto.

The display apparatus 400 may change the preview images of the contents displayed on the first to fourth split screens 411, 412, 413, and 414 according to the third user gesture.

To be specific, as shown in FIG. 4A, in response to a user gesture of moving a hand 40 in an arrow direction while touching the first split screen 411 of the display apparatus 400 with the hand, the display apparatus 400 may sense the third user gesture according to a movement of the hand 40.

In this case, as shown in FIG. 4B, the display apparatus 400 may display a preview image of a content provided from a “DVD” on the first split screen 411, instead of a preview image of a content provided from the “TV1.”

As described above, as the preview image of the content displayed on the split screen from which the third user gesture is sensed is changed, the user is able to change a preview image of a content and an input source which provides a content corresponding to the preview image of the content more easily. Accordingly, in response to a non-existence of a content that the user wishes to watch or a corresponding input source in the first to the fourth split screens 411, 412, 413, and 414 illustrated in FIG. 4A, the user is able to search for a desired content or input source by taking the third user gesture on any one of the split screens.

Meanwhile, in FIG. 4A, the third user gesture is a gesture of moving the hand 40 in an arrow direction within the first split screen 411, but not limited thereto. To be specific, the third user gesture may include a gesture of moving the hand 40 downwardly or a gesture of moving the hand 40 in a left direction or in a right direction, in any one of the split screens.

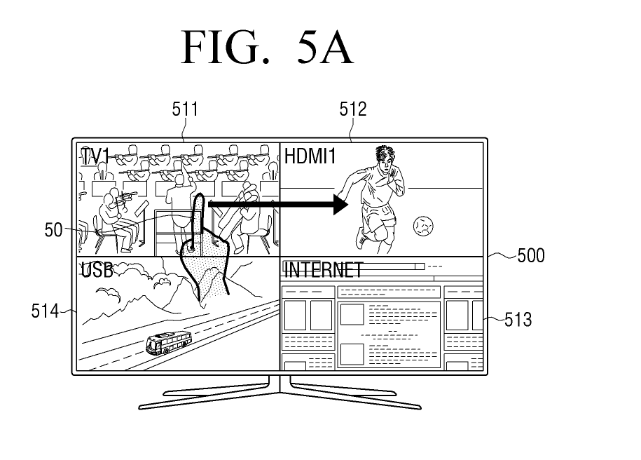

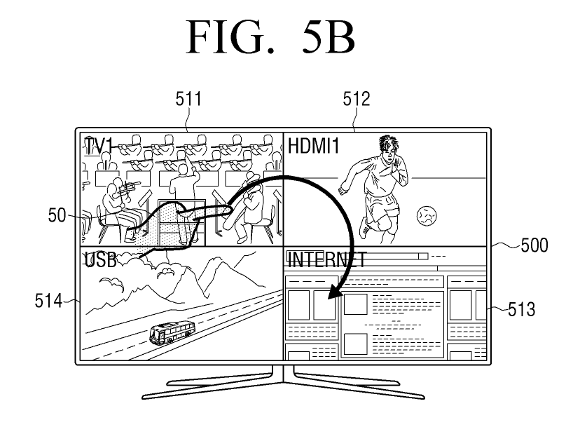

FIGS. 5A to 5B are diagrams provided to describe a method of executing the multi view mode according to the second user gesture. Referring to FIG. 5A, a display apparatus 500 displays a first to the fourth split screens 511, 512, 513, and 514 including preview images of different content images. In this case, the first to fourth split screens 511, 512, 513, and 514 may be displayed according to the method shown in FIGS. 3A to 3C or the method shown in FIGS. 4A to 4B.

In response to at least two or more split screens being selected from among the first to fourth split screens 511, 512, 513, and 514 according to the second user gesture, the display apparatus 500 may display a plurality of contents received from a plurality of input sources corresponding to the at least two or more selected split screens. According to an exemplary embodiment, the display apparatus 500 may generate and display a plurality of contents as a multi view content corresponding to a predetermined multi view mode.

As in FIG. 5A, in response to a user gesture of moving a hand 50 toward the second split screen 512 while touching the first split screen 511 with the hand 50, the display apparatus 500 may simultaneously display contents corresponding to the preview images displayed in the first split screen 511 and the second split screen 512.

FIG. 5B is a diagram provided to describe a method of executing a multi view mode according to the second user gesture of selecting three split screens. Referring to FIG. 513, in response to a user gesture of moving the hand 50 toward the third split screen 513 after passing through the second split screen 513 while touching the first split screen 511 with the hand 50, the first split screen 511, the second split screen 512, and the third split screen 513 may be connected by the touch. Accordingly, according to the second user gesture, the display apparatus 500 may display contents corresponding to the preview images displayed in the first split screen 511, the second split screen 512, and the third split screen 513.

As described above, a plurality of contents corresponding to a plurality of split screens which are selected by the second user gesture may be generated as a multi view content and displayed in the display apparatus 500. In this case, the multi view content may be provided in various methods. Hereinafter, it will be described with reference to FIGS. 6A to 6B.

FIG. 6A is a diagram provided to describe a method of providing a multi view content according to an exemplary embodiment. In response to the first split screen 511 and the second split screen 512 being selected according to the method of FIG. 5A, the display apparatus 500 may display a first content and a second content corresponding to preview images displayed in the first split screen 511 and the second split screen 512.

Specially, in response to image signals corresponding to the first content and the second content being received, the display apparatus 500 performs various image signal processing operations, such as decoding, de-interleaving, scaling, frame rate conversion, etc., with respect to each of the image signals, generates image frames, and combines the image frames.

Subsequently, the display apparatus 500 displays an image frame of the first content and an image frame of the second content alternately on a frame basis. In this case, a frame unit may be set to be at least one or more frames. For example, in response to two frames being set as a frame unit, frames may be displayed alternately in the manner of displaying two image frames of the first content and then displaying two image frames of the second content.

The display apparatus 500 may generate synchronization signals for synchronizing a display timing of the image frame of the first content and a display timing of the image frame of the second content with an operation of each of the eyeglasses 200-1 and 200-2, and transmit the synchronization signals to each of the eyeglasses 200-1 and 200-2.

The synchronization signals may be generated in various forms according to a wireless communication method which is applied between the display apparatus 500 and the eyeglasses 200-1 and 200-2. For example, the synchronization signals may be generated in a form of a Radio Frequency (RF) signal or an Infrared Rays (IR) signal, or may be generated in a form of a data packet according to various wireless communication standards such as Bluetooth, Wi-Fi, Zigbee, Institute of Electrical or Electronic Engineers (IEEE), etc.

In addition, the display apparatus 500 may transmit an audio signal of the first content and an audio signal of the second content to each of the eyeglasses 200-1 and 200-2. Accordingly, users are able to watch each of the first content and the second content through each of the eyeglasses 200-1 and 200-2.

FIG. 6A illustrates two eyeglasses 200-1 and 200-2. However, the number of eyeglasses is not limited thereto, and more eyeglasses may be used.

Meanwhile, in FIG. 6A, a user watches a multi view content using the eyeglasses. However, according to another exemplary embodiment, the user is able to watch the multi view content in different methods.

FIG. 6B is a view provided to describe a method of providing a multi view content according to another exemplary embodiment.

Referring to FIG. 6B, in response to the first split screen 511 and the second split screen 512 being selected according to the method of FIG. 5A, for example, the display apparatus 500 displays each of a first content and a second content which respectively correspond to preview images displayed in the first split screen 511 and the second split screen 512 in each of a first area 611 and a second area 612 of a screen. Accordingly, a user is able to watch the first content and the second content in a single screen.

In addition, the display apparatus 500 may provide each user with an audio of the first content and an audio of the second content using various methods.

As an example, the display apparatus 500 includes a plurality of headphone terminals. In response to a plurality of contents being displayed, each terminal outputs an audio of only one content. Accordingly, the user is able to listen to the audio of the first content using the headphone connected to a first terminal and listen to the audio of the second content using the headphone connected to a second terminal.

As another example, the display apparatus 500 may transmit audio data of a content to an external apparatus (for example, a smart phone, a remote controller, eyeglasses, another wearable device, and the like) having a headphone connecting terminal. In this case, a user is able to select and listen to audio data corresponding to a desired content from among a plurality of pieces of audio data which are transmitted from the display apparatus 500 to the external apparatus.

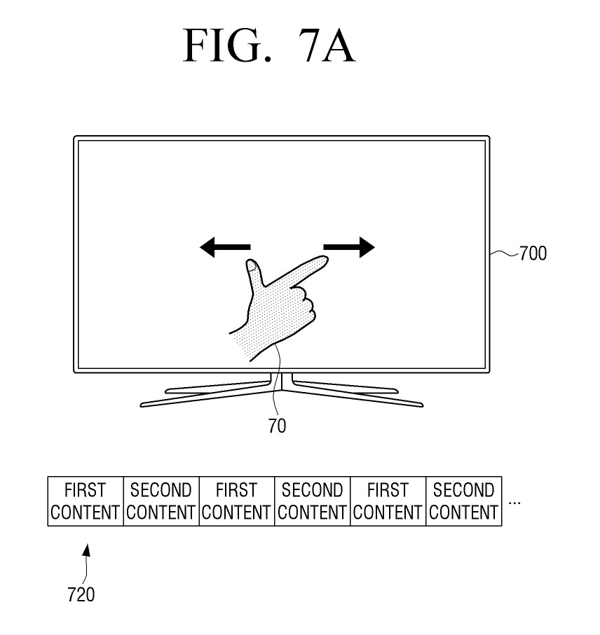

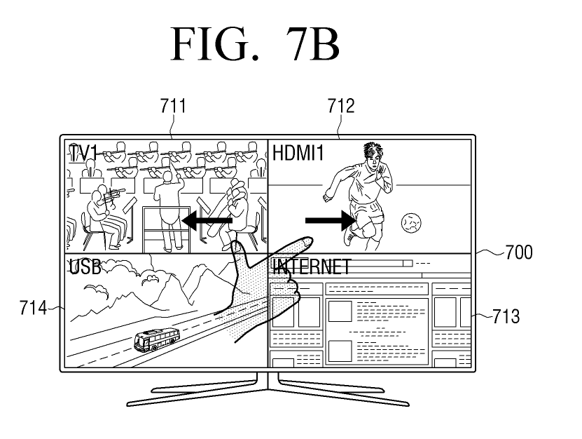

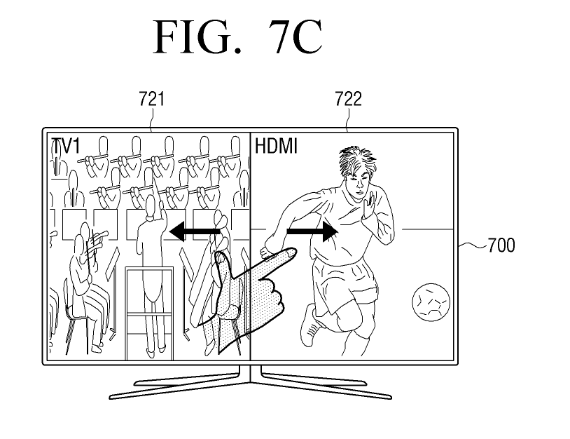

FIGS. 7A to 7C are diagrams provided to describe a method of controlling a display apparatus according to the fourth user gesture, according to an exemplary embodiment.

As in FIG. 7A, in response to the fourth user gesture being sensed while a frame of the first content and a frame of the second content are alternately displayed, a display apparatus 700 may display a plurality of split screens which respectively display preview images of contents. In this case, the fourth user gesture may be a gesture for terminating displaying a plurality of contents while the plurality of contents are displayed.

To be specific, in response to a user gesture of spreading a thumb and an index finger apart which were previously together, while simultaneously touching a screen with the hand 70, the display apparatus 700 displays a first to fourth split screens 711, 712, 713, and 714 as shown in FIG. 7B. In this case, the first to fourth split screens 711, 712, 713, and 714 may be screens displayed immediately before the plurality of contents are displayed. For example, the first to fourth split screens 711, 712, 713, and 714 may be a screen as illustrated in FIG. 5A, but not limited thereto. In response to the fourth user gesture being sensed, a predetermined number of split screens may be displayed. In this case, it is preferred that a plurality of split screens include two split screens with respect to the first content and the second content displayed together immediately before the fourth user gesture is sensed.

In response to the fourth user gesture being sensed multiple times, the display apparatus 700 may change the number of split screens according to the number of times of the fourth user gesture is sensed.

To be specific, in response to the fourth user gesture being sensed again while the first to fourth split screens 711, 712, 713, and 714 are displayed, the display apparatus 700 displays the first split screen 711 and the second split screen 712 as shown in FIG. 7C. That is, the number of split screens is reduced from four to two. In response to the fourth user gesture being sensed again according to such method, the display apparatus 700 may operate in the normal mode.

Meanwhile, in FIGS. 7A to 7C, the number of split screens is reduced according to the number of times the fourth user gesture is sensed, but not limited thereto. According to another exemplary embodiment, in response to the fourth user gesture being sensed, the display apparatus 700 may display only one predetermined content without performing an operation illustrated in FIGS. 7B and 7C. That is, only a content which is received from a predetermined input source may be displayed.

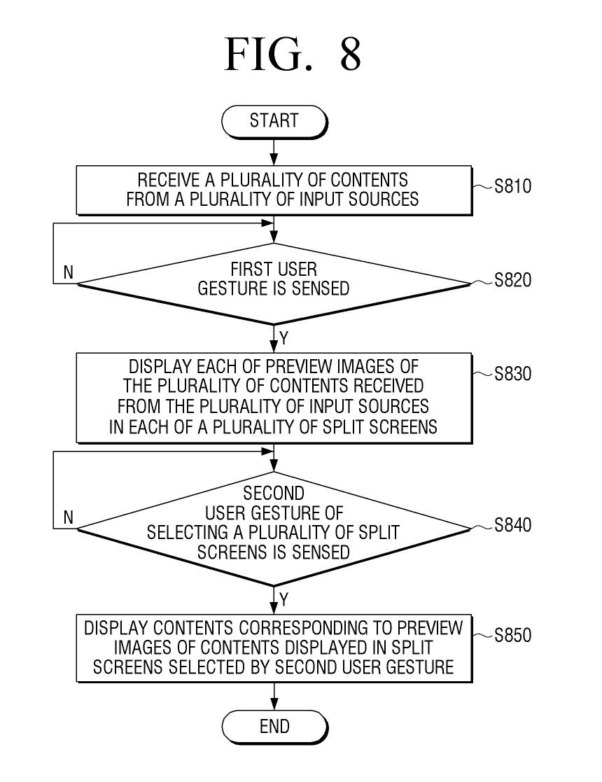

FIG. 8 is a flow chart provided to describe a method of displaying a multi view according to an exemplary embodiment. The method of displaying a multi view illustrated in FIG. 8 may be performed by a display apparatus.

First, a display apparatus receives a plurality of contents from a plurality of input sources (S810). In response to a first user gesture being sensed (S820), the display apparatus displays each of preview images of the plurality of contents received from the plurality of input sources in each of a plurality of split screens (S830). The first user gesture may be a user command for checking the preview images of the plurality of contents provided from the plurality of input sources in a single screen. In response to sensing the first user gesture once, two split screens including preview images of different content may be generated, and in response to sensing the first user gesture twice, four split screens including preview images of different content may be generated. Accordingly, the display apparatus may change the number of split screens according to the number of times being sensed of the first user gesture.

Meanwhile, in response to a second user gesture of selecting a plurality of split screens being sensed (S840), the display apparatus displays contents corresponding to the preview images of the contents displayed in the split screens selected by the second user gesture (S850). In this case, the second user gesture may be a user command for selecting split screens corresponding to a plurality of contents to be displayed together. Accordingly, in response to a plurality of split screens being selected by the second user gesture, the display apparatus may display the contents corresponding to the preview images of the contents displayed in the split screens selected by the second user gesture.

Meanwhile, in response to the second user gesture not being sensed while the preview images of the contents are displayed in the plurality of split screens, the display apparatus determines whether a predetermined time (for example, 30 seconds) elapses. In response to the predetermined time elapsing, the display apparatus may terminate displaying the preview images of the content in the plurality of split screens and display the content which has been displayed.

The method of displaying a multi view mode according to the aforementioned various exemplary embodiments may be coded as software. The software may be recorded in a non-transitory computer readable medium, and used in an apparatus such as a display apparatus or an eyeglasses apparatus.

The non-transitory computer readable medium refers to a medium which may store data semi-permanently rather than storing data for a short time such as a register, a cache, and a memory and may be readable by an apparatus. Specifically, the above-described various applications and programs may be stored in the non-transitory computer readable medium like a compact disc (CD), a digital versatile disk (DVD), a hard disk, a Blu-ray disk, a universal serial bus (USB), a memory card, and a read-only memory (ROM), etc., and provided therein.

As given above, although a few desirable exemplary embodiments have been shown and described, the present disclosure is not limited to the aforementioned particular exemplary embodiments, and could be variously modified and achieved by those skilled in the art to which the present disclosure pertains without deviating from the substance of the present disclosure which is claimed in the claims, and such modifications should not be understood separately from the technical concept or prospect of the present disclosure.

What is claimed is:

1. A display apparatus comprising:
a display;
a sensor configured to sense a user gesture;
a content receiver configured to receive contents from a plurality of input sources; and
a controller configured to, in response to a first user gesture being sensed, control the display to respectively display preview images of a plurality of contents received from the plurality of input sources in each of a plurality of split screens, and in response to a second user gesture of selecting a plurality of split screens being sensed, control the display to simultaneously display a plurality of contents corresponding to preview images displayed in a plurality of selected split screens.

2. The apparatus as claimed claim 1, wherein the controller controls the display to respectively display the plurality of contents corresponding to the preview images displayed in the plurality of selected split screens in different areas.

3. The apparatus as claimed in claim 1, wherein the controller controls the display to alternately display the plurality of contents corresponding to the preview images displayed in the plurality of selected split screens on a frame basis.

4. The apparatus as claimed in claim 1 further comprising:
a content processor configured to generate the plurality of contents corresponding to the preview images displayed in the plurality of selected split screens as a multi view content corresponding to a predetermined multi view mode and provide the display with the generated multi view content.

5. The apparatus as claimed in claim 1, wherein in response to the first user gesture being sensed multiple times, the controller changes a number of the split screens according to a number of times the first user gesture is sensed.

6. The apparatus as claimed in claim 1, wherein in response to a third user gesture for changing a content preview image displayed in each of the split screens being sensed, the controller changes the content preview image in each of the split screens according to the third user gesture.

7. The apparatus as claimed in claim 1, wherein in response to the second user gesture for connecting one of the plurality of split screens to at least one another split screen being sensed, the controller controls the display to simultaneously display a plurality of contents corresponding to preview images displayed in each of the split screens connected by the second user gesture.

8. The apparatus as claimed in claim 1, wherein the second user gesture is a gesture which individually selects a plurality of split screens.

9. The apparatus as claimed in claim 1, wherein in response to a predetermined time elapsing while preview images of a plurality of contents received from the plurality of input sources are displayed in each of a plurality of split screens, the controller controls the display to display only a content received from a pre-selected input source from among the plurality of input sources.

10. The apparatus as claimed in claim 1, wherein the controller controls the display to display identification information on each of a plurality of input sources in each of the plurality of split screens.

11. The apparatus as claimed in claim 1, wherein in response to a fourth user gesture being sensed while a plurality of contents are simultaneously displayed, the controller controls the display to display only a content received from a pre-selected input source.

12. A method of displaying a multi view of a display apparatus, the method comprising:
receiving contents from a plurality of input sources;
in response to a first user gesture being sensed, respectively displaying preview images of a plurality of contents received from the plurality of input sources in each of a plurality of split screens; and
in response to a second user gesture of selecting a plurality of split screens being sensed, simultaneously displaying a plurality of contents corresponding to preview images displayed in the plurality of selected split screens.

13. The method as claimed in claim 12, wherein the simultaneously displaying the plurality of contents comprises:
respectively displaying the plurality of contents corresponding to the preview images displayed in the plurality of selected split screens in different areas of a screen.

14. The method as claimed in claim 12, wherein the simultaneously displaying the plurality of contents comprises:
alternately displaying the plurality of contents corresponding to the preview images displayed in the plurality of selected split screens on a frame basis.

15. The method as claimed in claim 12 further comprising:
generating the plurality of contents corresponding to the preview images displayed in the plurality of selected split screens as a multi view content corresponding to a predetermined multi view mode.

16. The method as claimed in claim 12, wherein in response to the first user gesture being sensed multiple times, the respectively displaying the preview images of the plurality of contents received from the plurality of input sources in each of the plurality of split screens comprises changing a number of the split screens according to a number of times the first user gesture is sensed.

17. The method as claimed in claim 12 further comprising:
in response to a third user gesture for changing a content preview image displayed in each of the split screens being sensed, changing the content preview image in each of the split screens according to the third user gesture.

18. The method as claimed in claim 12, wherein in response to the second user gesture for connecting one of the plurality of split screens to at least another split screen being sensed, the simultaneously displaying the plurality of contents comprises simultaneously displaying a plurality of contents corresponding to preview images displayed in each of the split screens connected by the second user gesture.

19. The method as claimed in claim 12, wherein the second user gesture is a gesture which individually selects a plurality of split screens.

20. The method as claimed in claim 12 further comprising:
in response to a predetermined time elapsing while preview images of a plurality of contents received from the plurality of input sources are displayed in each of a plurality of split screens, displaying only a content received from a pre-selected input source from among the plurality of input sources.

21. The method as claimed in claim 12, wherein the respectively displaying the preview images of the plurality of contents received from the plurality of input sources in each of the plurality of split screens comprises displaying identification information on each of the plurality of input sources in each of the plurality of split screens.

22. The method as claimed in claim 12 further comprising:
in response to a fourth user gesture being sensed while a plurality of contents are displayed, displaying only a content received from a pre-selected input source.
